(19) United States
(12) Patent Application Publication
(10) Pub. No.: US 2017/0244716 A1
(43) Pub. Date: Aug. 24, 2017

(54) Apparatus and Method for Accessing a Network

(71) Applicant: Motorola Mobility LLC, Chicago, IL (US)

(72) Inventors: Sudhir C. Vissa, Bensenville, IL (US); Vivek K. Tyagi, Plantation, FL (US)

(21) Appl. No.: 15/047,167

(22) Filed: Feb. 18, 2016

(51) Int. Cl. H04L 29/06

(52) U.S. Cl. CPC H04L 63/102; H04L 63/083

(57) ABSTRACT

Apparatuses, methods, and program products are disclosed for accessing a network. One method includes receiving, at a second information handling device, a request from a first information handling device for access to a network accessible via the second information handling device. The method also includes determining, based on the request, whether the first information handling device is trusted by the second information handling device. The method includes determining network credentials including a username and a password for accessing the network in response to the first information handling device being trusted. The method also includes transmitting the network credentials from the second information handling device to the first information handling device.

### FIELD

The subject matter disclosed herein relates to networks and more particularly relates to accessing a network.

### BACKGROUND

### Description of the Related Art

Information handling devices, such as desktop computers, laptop computers, tablet computers, smart phones, optical head-mounted display units, smart watches, etc., are ubiquitous in society. Such devices may access a network to transmit and/or receive information. Devices may not have credentials to access a network.

### BRIEF SUMMARY

An apparatus for accessing a network is disclosed. A method and computer program product also perform the functions of the apparatus. In one embodiment, the apparatus includes a processor and a memory that stores code executable by the processor. The code, in various embodiments, is executable by the processor to receive a request from an information handling device for access to a network accessible via the apparatus. In a further embodiment, the code is executable by the processor to determine, based on the request, whether the information handling device is trusted by the apparatus. The code, in some embodiments, is executable by the processor to determine network credentials having a username and a password for accessing the network in response to the information handling device being trusted. In one embodiment, the code is executable by the processor to transmit the network credentials from the apparatus to the information handling device.

A method for accessing a network, in one embodiment, includes receiving, at a second information handling device, a request from a first information handling device for access to a network accessible via the second information handling device. In some embodiments, the method includes determining, based on the request, whether the first information handling device is trusted by the second information handling device. In a further embodiment, the method includes determining network credentials including a username and a password for accessing the network in response to the first information handling device being trusted. In certain embodiments, the method includes transmitting the network credentials from the second information handling device to the first information handling device.

In some embodiments, receiving the request from the first information handling device includes receiving the request using a communication method that excludes the Internet. In various embodiments, receiving the request from the first information handling device includes receiving the request using a communication method. In such embodiments, the communication method may be selected from the group including the Internet, short message service (“SMS”), multimedia messaging service (“MMS”), peer-to-peer communication, near-field communication (“NFC”), Bluetooth®, and Wi-Fi.

In one embodiment, the network accessible via the second information handling device includes an Internet connection. In certain embodiments, the network accessible via the second information handling device includes an access point. In some embodiments, the request includes one or more of a name, a phone number, an address, a contact entry, a social media identification, an international mobile station equipment identity (“IMEI”), a challenge/response message, a portion of a multi-step verification message, and a device identifier.

In various embodiments, determining whether the first information handling device is trusted by the second information handling device includes comparing information from the request with information accessible by the second information handling device. In one embodiment, the first and second information handling devices are mobile phones. In certain embodiments, transmitting the network credentials from the second information handling device to the first information handling device includes transmitting the network credentials using a communication method that excludes the Internet.

In some embodiments, transmitting the network credentials from the second information handling device to the first information handling device includes transmitting the network credentials using a communication method, the communication method selected from the group including the Internet, short message service (“SMS”), multimedia messaging service (“MMS”), peer-to-peer communication, near-field communication (“NFC”), Bluetooth®, and Wi-Fi.

In one embodiment, receiving the request from the first information handling device for access to the network accessible via the second information handling device includes receiving a request from each information handling device of multiple information handling devices for access to the network accessible via the second information handling device. In such embodiments, determining, based on the request, whether the first information handling device is trusted by the second information handling device includes determining whether each information handling device of multiple information handling devices is trusted by the second information handling device. Moreover, in such embodiments, determining the network credentials having the username and the password for accessing the network in response to the first information handling device being trusted includes determining network credentials for each information handling device of the multiple information handling devices in response to a respective information handling device being trusted. Further, in such embodiments, transmitting the network credentials from the second information handling device to the first information handling device includes transmitting network credentials for each information handling device of the multiple information handling devices from the second information handling device to a respective information handling device of the multiple information handling devices.

In certain embodiments, the method includes renegotiating a group key in response to: receiving, at the second information handling device, a request from a third information handling device for access to the network accessible via the second information handling device; determining, based on the request, whether the third information handling device is trusted by the second information handling device; determining second network credentials including a username and a password for accessing the network in response to the third information handling device being trusted; and transmitting the second network credentials from the second information handling device to the third information handling device.

In certain embodiments, the method includes rejecting the request based on operational conditions of the second information handling device. In such embodiments, the operational conditions may include one or more of a battery charge level, a number of connected devices, usage data, a signal strength boundary, and a network connection speed. In one embodiment, determining whether the first information handling device is trusted by the second information handling device includes manually accepting the request from the first information handling device. In various embodiments, determining whether the first information handling device is trusted by the second information handling device includes accepting the request without human interaction based on automatic acceptance criteria. In such embodiments, the automatic acceptance criteria may include one or more of usage data and a network connection speed.

Another method for accessing a network, in one embodiment, includes transmitting, from a first information handling device, a request to a second information handling device for access to a network accessible via the second information handling device. In such an embodiment, the second information handling device determines whether the first information handling device is trusted by the second information handling device. In some embodiments, the method includes receiving, at the first information handling device, network credentials from the second information handling device in response to the first information handling device being trusted. In such embodiments, the network credentials include a username and a password for accessing the network.

In one embodiment, transmitting the request to the second information handling device includes transmitting the request to the second information handling device using a communication method that excludes the Internet.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for accessing a network;

FIG. 2 is a schematic block diagram illustrating one embodiment of an apparatus including an information handling device;

FIG. 3 is a schematic block diagram illustrating one embodiment of an apparatus including a network sharing module;

FIG. 4 is a schematic block diagram illustrating another embodiment of an apparatus including a network sharing module;

FIG. 5 is a schematic flow chart diagram illustrating an embodiment of a method for accessing a network; and

FIG. 6 is a schematic flow chart diagram illustrating another embodiment of a method for accessing a network.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification have been labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

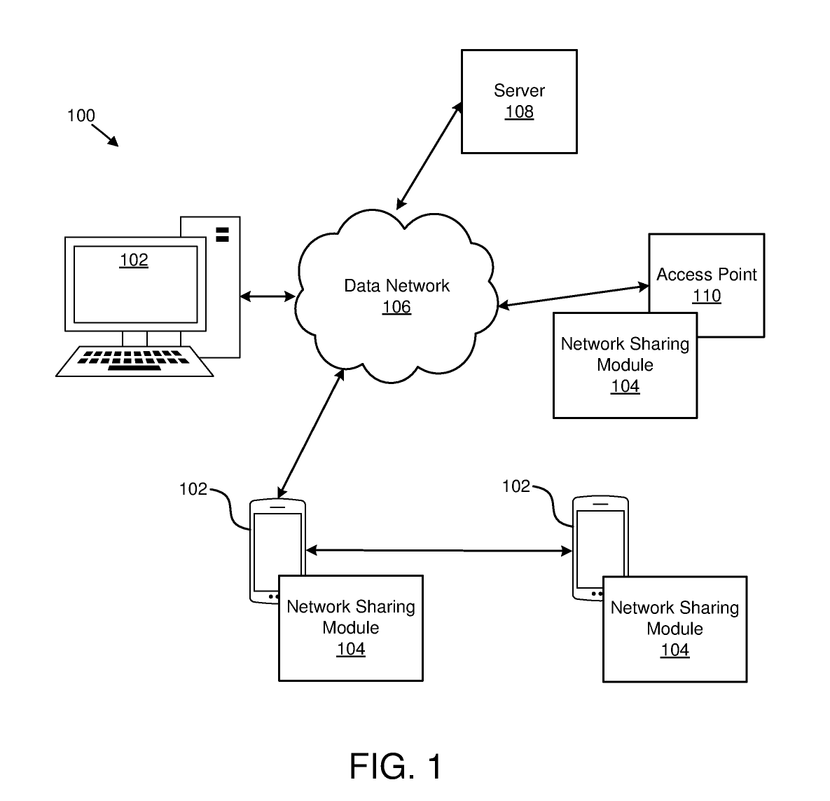

FIG. 1 depicts one embodiment of a system 100 for accessing a network. In one embodiment, the system 100 includes information handling devices 102, network sharing modules 104, data networks 106, servers 108, and access points 110. Even though a specific number of information handling devices 102, network sharing modules 104, data networks 106, servers 108, and access points 110 are depicted in FIG. 1, one of skill in the art will recognize that any number of information handling devices 102, network sharing modules 104, data networks 106, servers 108, and access points 110 may be included in the system 100.

In one embodiment, the information handling devices 102 include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the information handling devices 102 include wearable devices, such as smart watches, fitness bands, optical head-mounted displays, or the like. In certain embodiments, the information handling devices 102 may access the data network 106 directly using a network connection.

The information handling devices 102 may include an embodiment of the network sharing module 104. In certain embodiments, the network sharing module 104 may receive a request from another information handling device 102 for access to a network accessible via the network sharing module 104. The network sharing module 104 may determine, based on the request, whether the information handling device 102 is trusted by the network sharing module 104 (e.g., whether a user corresponding to the information handling device 102 is trusted by the network sharing module 104). The network sharing module 104 may also determine network credentials including a username and a password for accessing the network in response to the information handling device 102 being trusted. The network sharing module 104 may transmit the network credentials to the information handling device 102. In this manner, the network sharing module 104 may be used to grant network access to the information handling device 102. Using this technique, for example, one information handling device 102 (e.g., mobile phone) may be able to share its hotspot with another information handling device 102 (e.g., mobile phone).

In another embodiment, the network sharing module 104 may transmit a request to an information handling device 102 for access to a network accessible via the information handling device 102. In such an embodiment, the information handling device 102 determines whether the network sharing module 104 is trusted by the information handling device 102 (e.g., whether a user corresponding to the network sharing module 104 is trusted by the information handling device 102). The network sharing module 104 may receive network credentials from the information handling device 102 in response to the network sharing module 104 being trusted. In one embodiment, the network credentials may include a username and a password for accessing the network. In this manner, the network sharing module 104 may be used to receive network access from the information handling device 102. Using this technique, for example, one information handling device 102 (e.g., mobile phone) may be able to receive a shared hotspot from another information handling device 102 (e.g., mobile phone).

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a WAN, a storage area network (“SAN”), a LAN, an optical fiber network, the Internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, RAM, or the like.

In one embodiment, the servers 108 include computing devices, such as desktop computers, laptop computers, mainframe computers, cloud servers, virtual servers, and/or the like. In some embodiments, the servers 108 are designed as application servers, email servers, database servers, file servers, game servers, home servers, media servers, web servers, and/or the like. In certain embodiments, the servers 108 store data, and may be designed to be accessed by one or more information handling devices 102 through the network 106. The access points 110 may be any suitable access point, such as a router, a switch, a network node, a wireless router, a wireless access point, a Wi-Fi router, and so forth.

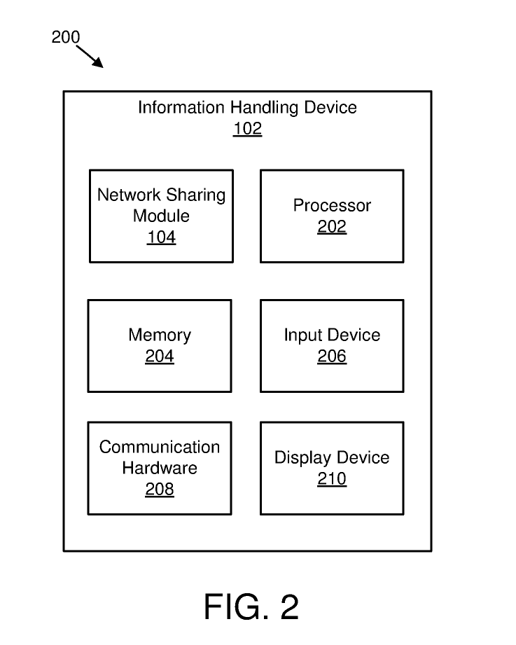

FIG. 2 depicts one embodiment of an apparatus 200 that may be used for accessing a network. The apparatus 200 includes one embodiment of the information handling device 102. Furthermore, the information handling device 102 may include the network sharing module 104, a processor 202, a memory 204, an input device 206, communication hardware 208, and a display device 210. In some embodiments, the input device 206 and the display device 210 are combined into a single device, such as a touchscreen.

Although the network sharing module 104 is illustrated as being part of the information handling device 102, in certain embodiments the network sharing module 104 may not be part of the information handling device 102. For example, the information handling device 102 may access a network sharing module 104 that is physically located on a separate device.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the network sharing module 104, the input device 206, the communication hardware 208, and the display device 210.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media.

In some embodiments, the memory 204 stores data relating to network access. In some embodiments, the memory 204 also stores program code and related data, such as an operating system or other controller algorithms operating on the information handling device 102.

The information handling device 102 may use the network sharing module 104 for accessing a network. As may be appreciated, the network sharing module 104 may include computer hardware, computer software, or a combination of both computer hardware and computer software. For example, the network sharing module 104 may include circuitry, or a processor, used to determine whether a user of an information handling device 102 is trusted. As another example, the network sharing module 104 may include computer program code that determines network credentials for accessing a network in response to the user being trusted.

The input device 206, in one embodiment, may include any known computer input device including a touch panel, a button, a keyboard, a stylus, or the like. In some embodiments, the input device 206 may be integrated with the display device 210, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel. The communication hardware 208 may facilitate communication with other devices. For example, the communication hardware 208 may enable communication via Bluetooth®, Wi-Fi, and so forth.

The display device 210, in one embodiment, may include any known electronically controllable display or display device. The display device 210 may be designed to output visual, audible, and/or haptic signals. In some embodiments, the display device 210 includes an electronic display capable of outputting visual data to a user. For example, the display device 210 may include, but is not limited to, an LCD display, an LED display, an OLED display, a projector, or similar display device capable of outputting images, text, or the like to a user. As another, non-limiting, example, the display device 210 may include a wearable display such as a smart watch, smart glasses, a heads-up display, or the like. Further, the display device 210 may be a component of a smart phone, a personal digital assistant, a television, a table computer, a notebook (laptop) computer, a personal computer, a vehicle dashboard, or the like.

In certain embodiments, the display device 210 includes one or more speakers for producing sound. For example, the display device 210 may produce an audible alert or notification (e.g., a beep or chime) upon receiving a request for access to a network. In some embodiments, the display device 210 includes one or more haptic devices for producing vibrations, motion, or other haptic feedback. For example, the display device 210 may produce haptic feedback upon receiving a request for access to a network.

In some embodiments, all or portions of the display device 210 may be integrated with the input device 206. For example, the input device 206 and display device 210 may form a touchscreen or similar touch-sensitive display. In other embodiments, the display device 210 may be located near the input device 206. In certain embodiments, the display device 210 may receive instructions and/or data for output from the processor 202 and/or the network sharing module 104.

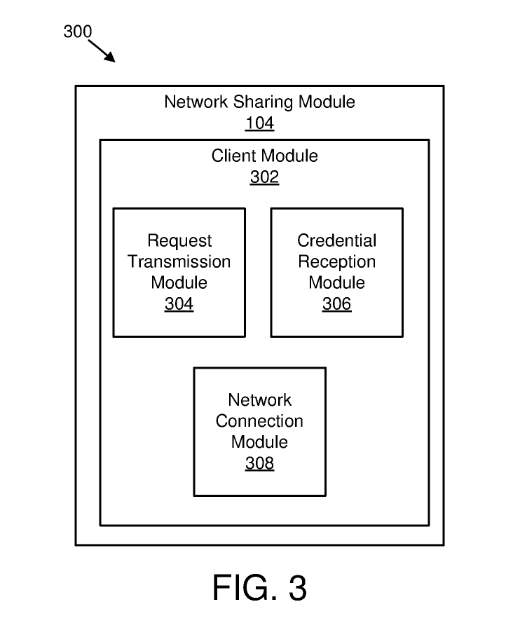

FIG. 3 depicts a schematic block diagram illustrating one embodiment of an apparatus 300 that includes one embodiment of the network sharing module 104. Furthermore, the network sharing module 104 includes a client module 302 that further includes a request transmission module 304, a credential reception module 306, and a network connection module 308.

The client module 302 may be used to gain access to a network. For example, the client module 302 may not have access to a network (e.g., the Internet, an access point 110 such as a Wi-Fi router). Accordingly, the client module 302 may request access to the network and receive credentials that may be used to access to the network. The client module 302 may then access the network. As may be appreciated, in certain embodiments, the client module 308 may be part of a mobile phone. In one embodiment, the client module 302 may include software that is standard an information handling device 102. For example, the client module 302 may include a messaging software used to send the request for access to the network and for receiving the credentials used to access the network.

The request transmission module 304 may transmit a request to an information handling device 102 for access to a network accessible via the information handling device 102. The information handling device 102 may determine whether the client module 302 is trusted by the information handling device 102 (e.g., whether a user corresponding to the client module 302 is trusted by the information handling device 102). In certain embodiments, the network accessible via the information handling device 102 includes an Internet connection. For example, the information handling device 102 may create a mobile hotspot, and the network may be the mobile hotspot accessible via the information handing device 102.

In some embodiments, the network accessible via the information handling device 102 includes an access point 110. For example, the information handling device 102 may have access to an access point 110 (e.g., Wi-Fi router). In such an example, the access point 110 may be any Wi-Fi router that the information handling device 102 has the ability to configure. The information handling device 102 may provide access to the access point 110 by configuring the access point 110 with credentials (e.g., a user name and password) for authenticating with the access point 110. In certain embodiments, the information handling device 102 is part of a mobile phone.

In various embodiments, the request from the request transmission module 304 includes one or more of a name, a phone number, an address, a contact entry, a social media identification, an international mobile station equipment identity (“IMEI”), a challenge/response message, a portion of a multi-step verification message, and a device identifier, for example. Accordingly, information from the request may be used by the information handling device 102 to determine whether the client module 302 is trusted.

In one embodiment, the request transmission module 304 may transmit the request to the information handling device 102 using a communication method that excludes the Internet. For example, the request transmission module 304 may not have access to the Internet for making the request; therefore, the request transmission module 304 may use a communication method that is not the Internet. Moreover, in another embodiment, the request transmission module 304 may transmit the request to the information handling device 102 using a communication method that includes at least one of the Internet, short message service (“SMS”), multimedia messaging service (“MMS”), peer-to-peer communication, near-field communication (“NFC”), Bluetooth, Wi-Fi, e-mail, and voicemail.

In certain embodiments, the request transmission module 304 may automatically (e.g., without human intervention) transmit the request to another device (e.g., a different information handling device 102, an access point 110) based on the operational conditions of the client module 302. As may be appreciated, such operational conditions may include one or more of a battery charge level, a carrier data plan, usage data, a signal strength boundary, a network connection speed, and packet loss (e.g., at the RF(L1/L2), at L4(IP layer), etc.).

For example, in one embodiment, the request transmission module 304 may automatically transmit a request to an information handling device 102 for access to a hotspot of the information handling device 102. In another example, the request transmission module 304 may automatically transmit a request to an information handling device 102 for access to an access point 110 associated with the information handling device 102. In such an example, the information handling device 102 may be used to direct the access point 110 to facilitate authentication with the client module 302. In a further example, the request transmission module 304 may automatically transmit a request to an access point 110 for access to the access point 110. In such an example, the access point 110 may communicate with an associated information handling device 102 to determine whether the client module 302 corresponds to a trusted device (e.g., user of the device).

In some embodiments, the credential reception module 306 may receive network credentials from the information handling device 102 in response to the client module 302 being trusted. The network credentials may include a username and a password for accessing the network.

In one embodiment, the credential reception module 306 may receive the network credentials from the information handling device 102 using a communication method that excludes the Internet. For example, the credential reception module 306 may not have access to the Internet for receiving the network credentials; therefore, the credential reception module 306 may use a communication method that is not the Internet. In another embodiment, the credential reception module 306 may receive the network credentials from the information handling device 102 using a communication method that includes at least one of the Internet, SMS, MMS, peer-to-peer communication, NFC, Bluetooth, Wi-Fi, e-mail, and voicemail.

In one embodiment, the network connection module 308 may use the network credentials to access the network. For example, the network connection module 308 may use the network credentials to obtain authentication to a mobile hotspot available through the information handling device 102. In another example, the network connection module 308 may use the network credentials to obtain authentication to a Wi-Fi router, or another access point 110. In certain embodiments, the network credentials may only be valid for a predetermined period of time. Accordingly, the network credentials may expire after the predetermined period of time has elapsed.

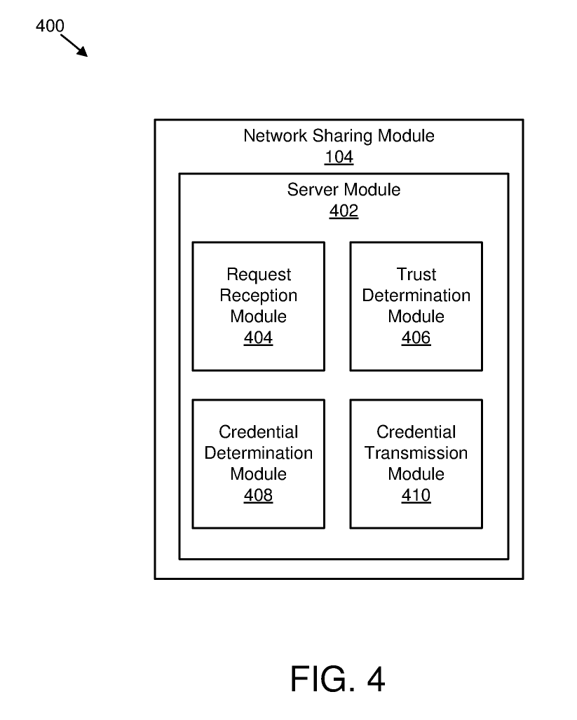

FIG. 4 is a schematic block diagram illustrating another embodiment of an apparatus 400 that includes one embodiment of the network sharing module 104. Furthermore, the network sharing module 104 includes a server module 402 that further includes a request reception module 404, a trust determination module 406, a credential determination module 408, and a credential transmission module 410.

The server module 402 may be used to provide access to a network. For example, the server module 402 may have access to a network (e.g., the Internet, an access point 110 such as a Wi-Fi router) that the client module 302 would like to have access to. Accordingly, the server module 402 may receive a request for access to the network and provide credentials that may be used to access to the network. The client module 302 may then access the network. As may be appreciated, in certain embodiments, the server module 402 may be part of a mobile phone.

In various embodiments, the request reception module 404 may receive a request from an information handling device 102 for access to a network (e.g., mobile hotspot, the Internet, an access point 110, a Wi-Fi router) accessible via the server module 402. In some embodiments, the request reception module 404 may receive the request from the information handling device 102 using a communication method that excludes the Internet. For example, the information handling device 102 may not have access to the Internet for transmitting the request; therefore, the information handling device 102 may use a communication method that is not the Internet.

In one embodiment, the request reception module 404 may receive the request from the information handling device 102 using a communication method that includes the Internet, SMS, MMS, peer-to-peer communication, NFC, Bluetooth, Wi-Fi, e-mail, and voicemail. For example, the request reception module 404 may receive the request from the information handling device 102 via a messaging software. In one embodiment, messages received by the messaging software may be monitored, and if a predetermined keyword and/or syntax is detected, the request reception module 404 may process the message. In certain embodiments, the network accessible via the server module 402 includes an Internet connection (e.g., made available as a mobile hotspot). In another embodiment, the network accessible via the server module 402 includes an access point 110 (e.g., a Wi-Fi router).

In various embodiments, the request may include any suitable information that may be used to identify the information handling device 102 (e.g., a user of the information handling device 102). For example, the information may include one or more of a name, a phone number, an address, a contact entry, a social media identification, an IMEI, a challenge/response message, a portion of a multi-step verification message, and a device identifier. In certain embodiments, the request may include a requested duration of time that the information handling device 102 would like to have access to the network. In some embodiments, the request may include an amount of data that the information handling device 102 would like to access through the network. In one embodiment, the information handling device 102 transmitting the request is a mobile phone.

In some embodiments, the request reception module 404 may receive a request from multiple information handling devices 102 for access to the network accessible via the server module 402. In such embodiments, multiple information handling devices 102 may be permitted to simultaneously access the network via the server module 402.

In certain embodiments, the trust determination module 406 may determine whether the information handling device 102 sending the request is trusted by the server module 402 (e.g., whether a user corresponding to the information handling device 102 sending the request is trusted by the server module 402). In various embodiments, a trusted information handling device 102 may correspond to a user that a user of the server module 402 personally knows, has information about, has previously contacted, and so forth. In some embodiments, the trust determination module 406 may determine whether the information handling device 102 is trusted by comparing information from the request with information accessible by the server module 402 (e.g., looking up the phone number of the information handling device 102 in a contacts list). As may be appreciated, information accessible by the server module 402 may include a name, a phone number, an address, an address book, a contact entry, a device identifier, a social media identification (e.g., social media contacts, social media friends), a predetermined list of users, an IMEI, a challenge/response message, a portion of a multi-step verification message, and so forth.

In some embodiments, the trust determination module 406 may display a name of a user requesting access to the network, a duration of time that access is being requested, and/or an amount of data that the information handling device 102 is requesting to access. Furthermore, in certain embodiments, the trust determination module 406 may prompt a user of the server module 402 to authorize or decline the request for access to the network (e.g., by displaying a requester's name, duration of time access is being requested, and/or amount of data the information handling device 102 is requesting).

In one embodiment, the trust determination module 406 may determine whether the information handling device 102 is trusted by determining whether each information handling device 102 of multiple information handling devices 102 is trusted by the server module 402. In certain embodiments, the trust determination module 406 may facilitate manual acceptance of the request from the information handling device 102, while in other embodiments, the trust determination module 406 may accept the request without human interaction based on automatic acceptance criteria. In embodiments that use an automatic acceptance criteria, the automatic acceptance criteria may include one or more of usage data and a network connection speed.

In some embodiments, the credential determination module 408 may determine network credentials including a username and a password for accessing the network in response to the information handling device 102 being trusted (e.g., the user of the server module 402 accepting/authorizing the request from the user seeking to be trusted). In one embodiment, the credential determination module 408 may directly determine network credentials for a mobile hotspot. The network credentials may be temporary, such as for a certain period of time and/or for a predetermined amount of data (e.g., data quota). In certain embodiments, the credential determination module 408 may set a timer and/or a data monitor to inhibit use of the credentials when the time limit or data limit is reached.

In another embodiment, the credential determination module 408 may communicate with an access point 110 to facilitate determining the network credentials. In certain embodiments, he credential determination module 408 may determine network credentials for each information handling device 102 of multiple information handling devices 102 in response to a respective user of the information handling device 102 being trusted.

In one embodiment, the credential transmission module 410 may transmit the network credentials to the information handling device 102. In certain embodiments, the credential transmission module 410 may transmit the network credentials to the information handling device 102 using a communication method that excludes the Internet. For example, the information handling device 102 may not have access to the Internet for receiving the network credentials; therefore, the credential transmission module 410 may use a communication method that is not the Internet. As another example, the credential transmission module 410 may send a message through a same messaging application that received the request for access.

In various embodiments, the credential transmission module 410 may transmit the network credentials to the information handling device 102 using a communication method that includes one of the Internet, SMS, MMS, peer-to-peer communication, NFC, Bluetooth, Wi-Fi, e-mail, and voicemail. In one embodiment, the credential transmission module 410 may transmit the network credentials to the information handling device 102 for each information handling device 102 of multiple information handling devices 102 to a respective information handling device 102 of the multiple information handling devices 102.

In some embodiments, the server module 402 may renegotiate a group key in response to: receiving a request from an additional information handling device 102 for access to the network accessible via the server module 402; determining, based on the request, whether the additional information handling device 102 is trusted by the server module 402; determining second network credentials including a username and a password for accessing the network in response to the additional information handling device 102 being trusted; and transmitting the second network credentials from the server module 402 to the additional information handling device 102. Accordingly, the server module 402 may facilitate multiple information handling devices 102 accessing the network using different credentials. As may be appreciated, renegotiating the group key may include renegotiating the group key for every connected device so that no previously connected device is dropped during provisioning of a new device with access to the network. Furthermore, the server module 402 may drop each device after a specified time period (e.g., timeout) and renegotiate the group key so that the device that is dropped cannot get access to the network after its specified time period until another access request is received from that device.

In various embodiments, the server module 402 may reject the request based on operational conditions of the server module 402. In such embodiments, the operational conditions may include one or more of a battery charge level, a number of connected devices, usage data, a signal strength boundary, and a network connection speed.

In one embodiment, the server module 402 may drop a connected device (e.g., having the client module 302) based on operational conditions of the server module 402. As may be appreciated, such operational conditions may include one or more of a battery charge level, a carrier data plan, usage data, a signal strength boundary, a network connection speed, and packet loss (e.g., at the RF(L1/L2), at L4(IP layer), etc.).

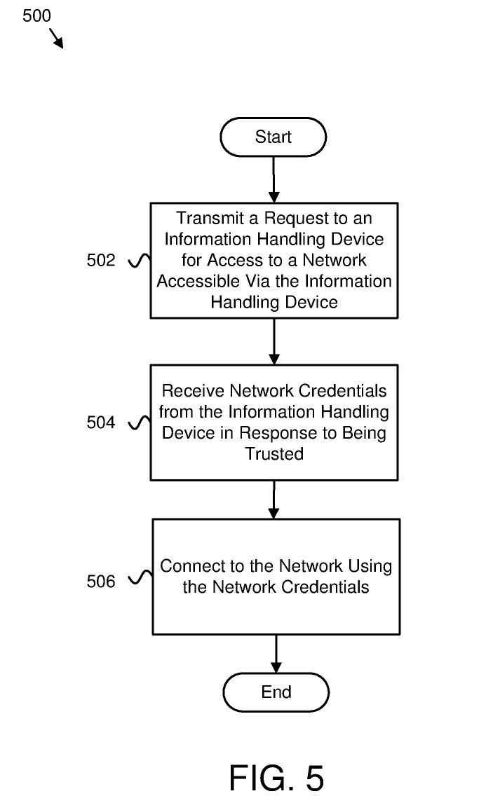

FIG. 5 is a schematic flow chart diagram illustrating an embodiment of a method 500 for accessing a network. In some embodiments, the method 500 is performed by an apparatus, such as the information handling device 102. In other embodiments, the method 500 may be performed by a module, such as the network sharing module 104 and/or the client module 302. In certain embodiments, the method 500 may be performed by a processor executing program code, for example, a microcontroller, a microprocessor, a CPU, a GPU, an auxiliary processing unit, a FPGA, or the like.

The method 500 may include transmitting 502 a request to an information handling device 102 for access to a network accessible via the information handling device 102. In certain embodiments, the information handling device 102 determines whether the requesting device is trusted by the information handling device 102 (e.g., whether a user corresponding to the requesting device is trusted by the information handling device 102). In certain embodiments, the request transmission module 304 may transmit 502 the request to the information handling device 102 for access to the network. Moreover, in some embodiments, the information handling device 102 may determine whether the requesting device is trusted by the information handling device 102. In certain embodiments, the network accessible via the information handling device 102 includes an Internet connection (e.g., mobile hotspot). In some embodiments, the network accessible via the information handling device 102 includes an access point 110 (e.g., Wi-Fi router). In certain embodiments, the information handling device 102 and/or the requesting device is part of a mobile phone.

In various embodiments, the request includes one or more of a name, a phone number, an address, a contact entry, a social media identification, an IMEI, a challenge/response message, a portion of a multi-step verification message, and a device identifier.

In one embodiment, the method 500 may transmit 502 the request to the information handling device 102 using a communication method that excludes the Internet. In another embodiment, the method 500 may transmit 502 the request to the information handling device 102 using a communication method that includes at least one of the Internet, SMS, MMS, peer-to-peer communication, NFC, Bluetooth®, and Wi-Fi.

The method 500 may also include receiving 504 network credentials from the information handling device 102 in response to the requesting device being trusted. In one embodiment, the network credentials include a username and a password for accessing the network. In certain embodiments, the credential reception module 306 may receive 504 the network credentials from the information handling device 102 in response to the requesting device being trusted. In one embodiment, the method 500 may receive 504 the network credentials from the information handling device 102 using a communication method that excludes the Internet. In another embodiment, the method 500 may receive 504 the network credentials from the information handling device 102 using a communication method that includes at least one of the Internet, SMS, MMS, peer-to-peer communication, NFC, Bluetooth®, and Wi-Fi.

The method 500 may also include connecting 506 to the network using the network credentials, and the method 500 may end. In certain embodiments, the network connection module 308 may connect 506 to the network using the network credentials.

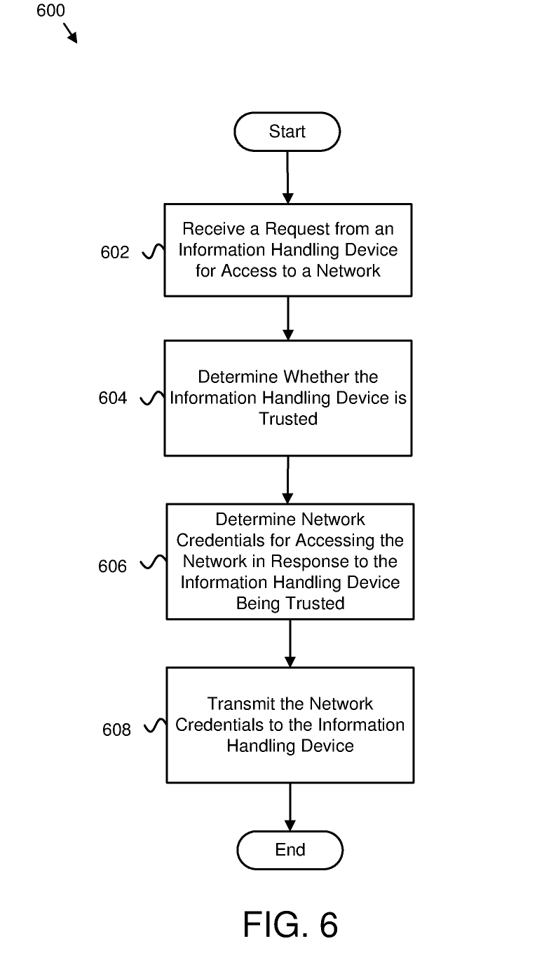

FIG. 6 is a schematic flow chart diagram illustrating an embodiment of a method 600 for accessing a network. In some embodiments, the method 600 is performed by an apparatus, such as the information handling device 102. In other embodiments, the method 600 may be performed by a module, such as the network sharing module 104 and/or the server module 402. In certain embodiments, the method 600 may be performed by a processor executing program code, for example, a microcontroller, a microprocessor, a CPU, a GPU, an auxiliary processing unit, a FPGA, or the like.

The method 600 may include receiving 602 a request from an information handling device 102 for access to a network accessible via the receiving device. In certain embodiments, the request reception module 404 may receive 602 the request from the information handling device 102 for access to the network accessible via the receiving device. In one embodiment, the method 600 may receive 602 the request using a communication method that excludes the Internet. In another embodiment, the method 600 may receive 602 the request using a communication method, and the communication method may include at least one of the Internet, SMS, MMS, peer-to-peer communication, NFC, Bluetooth®, and Wi-Fi. In certain embodiments, the network accessible via the receiving device includes an Internet connection (e.g., mobile hotspot). In one embodiment, the network accessible via the receiving device includes an access point 110 (e.g., Wi-Fi router). In various embodiments, the request includes one or more of a name, a phone number, an address, a contact entry, a social media identification, an IMEI, a challenge/response message, a portion of a multi-step verification message, and a device identifier. In some embodiments, the information handling device 102 and/or the receiving device are mobile phones. In some embodiments, the method 600 may receive 602 a request from each information handling device 102 out of multiple information handling devices 102 for access to the network accessible via the receiving device.

The method 600 may also include determining 604, based on the request, whether the information handling device 102 is trusted by the receiving device (e.g., whether a user corresponding to the information handling device 102 is trusted by the receiving device). In certain embodiments, the trust determination module 406 may determine 604, based on the request, whether the information handling device 102 is trusted by the receiving device.

In one embodiment, determining 604 whether the information handling device 102 is trusted by the receiving device includes comparing information from the request with information accessible by the receiving device. In another embodiment, determining 604, based on the request, whether the information handling device 102 is trusted by the receiving device includes determining whether each information handling device 102 of multiple information handling devices is trusted by the receiving device. In certain embodiments, determining 604 whether the information handling device 102 is trusted by the receiving device includes manually accepting the request from the information handling device 102. In various embodiments, determining 604 whether the information handling device 102 is trusted by the receiving device includes accepting the request without human interaction based on automatic acceptance criteria. In such an embodiment, the automatic acceptance criteria may include one or more of usage data and a network connection speed.

The method 600 may determine 606 network credentials including a username and a password for accessing the network in response to the information handling device 102 being trusted. In one embodiment, the credential determination module 408 may determine 606 the network credentials including the username and the password for accessing the network in response to the information handling device 102 being trusted. In certain embodiments, determining 606 the network credentials for accessing the network in response to the information handling device 102 being trusted includes determining network credentials for each information handling device 102 of multiple information handling devices 102 in response to a respective information handling device 102 being trusted.

The method 600 may also transmit 608 the network credentials from the receiving device to the information handling device 102, and the method 600 may end. In one embodiment, the credential transmission module 410 may transmit 608 the network credentials from the receiving device to the information handling device 102. In some embodiments, transmitting 608 the network credentials from the receiving device to the information handling device 102 includes transmitting the network credentials using a communication method that excludes the Internet.

In various embodiments, transmitting 608 the network credentials from the requesting device to the information handling device 102 includes transmitting the network credentials using a communication method. In such embodiments, the communication method may include at least one of the Internet, SMS, MMS, peer-to-peer communication, NFC, Bluetooth®, and Wi-Fi. In one embodiment, transmitting 608 the network credentials from the receiving device to the information handling device 102 includes transmitting network credentials for each information handling device 102 of multiple information handling devices 102 from the receiving device to a respective information handling device 102 of the multiple information handling devices 102.

In some embodiments, the method 600 may include renegotiating a group key in response to: receiving a request from an additional information handling device 102 for access to the network accessible via the receiving device; determining, based on the request, whether the additional information handling device 102 is trusted by the receiving device; determining second network credentials including a username and a password for accessing the network in response to the additional information handling device 102 being trusted; and transmitting the second network credentials from the receiving device to the additional information handling device 102.

In various embodiments, the method 600 includes rejecting the request based on operational conditions of the receiving device. In certain embodiments, the operational conditions may include one or more of a battery charge level, a number of connected devices, usage data, a signal strength boundary, a network connection speed, and packet loss (e.g., at the RF(L1/L2), at L4(IP layer), etc.). Moreover, in some embodiments, the method 600 may include blocking and/or disabling certain data traffic (e.g., via a firewall). For example, certain applications may be blocked to reduce data usage, such as video and/or audio streaming.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor;
a memory that stores code executable by the processor to:
receive a request from an information handling device for access to a network accessible via the apparatus;
determine, based on the request, whether the information handling device is trusted by the apparatus;
determine network credentials comprising a username and a password for accessing the network in response to the information handling device being trusted; and
transmit the network credentials from the apparatus to the information handling device.

2. A method comprising:
receiving, at a second information handling device, a request from a first information handling device for access to a network accessible via the second information handling device;
determining, based on the request, whether the first information handling device is trusted by the second information handling device;
determining network credentials comprising a username and a password for accessing the network in response to the first information handling device being trusted; and
transmitting the network credentials from the second information handling device to the first information handling device.

3. The method of claim 2, wherein receiving the request from the first information handling device comprises receiving the request using a communication method that excludes the Internet.

4. The method of claim 2, wherein receiving the request from the first information handling device comprises receiving the request using a communication method, the communication method selected from the group consisting of the Internet, short message service (“SMS”), multimedia messaging service (“MMS”), peer-to-peer communication, near-field communication (“NFC”), Bluetooth®, and Wi-Fi.

5. The method of claim 2, wherein the network accessible via the second information handling device comprises an Internet connection.

6. The method of claim 2, wherein the network accessible via the second information handling device comprises an access point.

7. The method of claim 2, wherein the request comprises one or more of a name, a phone number, an address, a contact entry, a social media identification, an international mobile station equipment identity (“IMEI”), a challenge/response message, a portion of a multi-step verification message, and a device identifier.

8. The method of claim 2, wherein determining whether the first information handling device is trusted by the second information handling device comprises comparing information from the request with information accessible by the second information handling device.

9. The method of claim 2, wherein the first and second information handling devices are mobile phones.

10. The method of claim 2, wherein transmitting the network credentials from the second information handling device to the first information handling device comprises transmitting the network credentials using a communication method that excludes the Internet.

11. The method of claim 2, wherein transmitting the network credentials from the second information handling device to the first information handling device comprises transmitting the network credentials using a communication method, the communication method selected from the group consisting of the Internet, short message service (“SMS”), multimedia messaging service (“MMS”), peer-to-peer communication, near-field communication (“NFC”), Bluetooth®, and Wi-Fi.

12. The method of claim 2, wherein:
receiving the request from the first information handling device for access to the network accessible via the second information handling device comprises receiving a request from each information handling device of a plurality of information handling devices for access to the network accessible via the second information handling device;
determining, based on the request, whether the first information handling device is trusted by the second information handling device comprises determining whether each information handling device of the plurality of information handling devices is trusted by the second information handling device;
determining the network credentials comprising the username and the password for accessing the network in response to the first information handling device being trusted comprises determining network credentials for each information handling device of the plurality of information handling devices in response to a respective information handling device being trusted; and
transmitting the network credentials from the second information handling device to the first information handling device comprises transmitting network credentials for each information handling device of the plurality of information handling devices from the second information handling device to a respective information handling device of the plurality of information handling devices.

13. The method of claim 2, comprising renegotiating a group key in response to:
receiving, at the second information handling device, a request from a third information handling device for access to the network accessible via the second information handling device;
determining, based on the request, whether the third information handling device is trusted by the second information handling device;
determining second network credentials comprising a username and a password for accessing the network in response to the third information handling device being trusted; and
transmitting the second network credentials from the second information handling device to the third information handling device.

14. The method of claim 2, further comprising rejecting the request based on operational conditions of the second information handling device.

15. The method of claim 14, wherein the operational conditions comprise one or more of a battery charge level, a number of connected devices, usage data, a signal strength boundary, and a network connection speed.

16. The method of claim 2, wherein determining whether the first information handling device is trusted by the second information handling device comprises manually accepting the request from the first information handling device.

17. The method of claim 2, wherein determining whether the first information handling device is trusted by the second information handling device comprises accepting the request without human interaction based on automatic acceptance criteria.

18. The method of claim 17, wherein the automatic acceptance criteria comprises one or more of usage data and a network connection speed.

19. A method comprising:
transmitting, from a first information handling device, a request to a second information handling device for access to a network accessible via the second information handling device, wherein the second information handling device determines whether the first information handling device is trusted by the second information handling device; and
receiving, at the first information handling device, network credentials from the second information handling device in response to the first information handling device being trusted, wherein the network credentials comprise a username and a password for accessing the network.

20. The method of claim 19, wherein transmitting the request to the second information handling device comprises transmitting the request to the second information handling device using a communication method that excludes the Internet.
